(19) United States
(12) Patent Application Publication
(10) Pub. No.: US 2022/0203551 A1
(43) Pub. Date: Jun. 30, 2022

(54) LUGGAGE TRANSPORT SYSTEM, LUGGAGE TRANSPORT METHOD, AND STORAGE MEDIUM

(71) Applicant: TOYOTA JIDOSHA KABUSHIKI KAISHA, Toyota-shi Aichi-ken (JP)

(72) Inventors: Shiro Oda, Anjo-shi Aichi-ken (JP); Tetsuya Taira, Nagakute-shi Aichi-ken (JP); Satoshi Toyoshima, Okazaki-shi Aichi-ken (JP); Yuta Watanabe, Toyota-shi Aichi-ken (JP); Takeshi Matsui, Nisshin-shi Aichi-ken (JP); Takayoshi Nasu, Okazaki-shi Aichi-ken (JP); Kei Yoshikawa, Nagoya-shi Aichi-ken (JP); Yusuke Ota, Nagakute-shi Aichi-ken (JP); Yutaro Ishida, Toyota-shi Aichi-ken (JP); Yuji Onuma, Nagoya-shi Aichi-ken (JP); Kyosuke Arai, Toyota-shi Aichi-ken (JP)

(73) Assignee: TOYOTA JIDOSHA KABUSHIKI KAISHA, Toyota-shi Aichi-ken (JP)

(21) Appl. No.: 17/494,386

(22) Filed: Oct. 5, 2021

(30) Foreign Application Priority Data
Dec. 24, 2020 (JP) 2020-214748

(51) Int. Cl. B25J 11/00; B25J 5/00; B25J 9/16

(52) U.S. Cl. CPC B25J 11/008; B25J 19/02; B25J 9/1666; B25J 5/007

(57) ABSTRACT

A luggage transport system includes: a transport robot that transports luggage to a destination while moving such that a distance from an obstacle does not become equal to or smaller than a predetermined value; and a predetermined value changing unit for changing the predetermined value according to at least one of the luggage, a moving speed of the transport robot, and a state of a road surface on which the transport robot moves.

### CROSS-REFERENCE TO RELATED APPLICATION

This application claims priority to Japanese Patent Application No. 2020-214748 filed on Dec. 24, 2020, incorporated herein by reference in its entirety.

### BACKGROUND

### 1. Technical Field

The present disclosure relates to a luggage transport system, a luggage transport method, and a storage medium.

### 2. Description of Related Art

There are known robots that move autonomously while keeping a distance from obstacles (see, for example, Japanese Patent No. 6069606 (JP 6069606 B)). For such a robot, a predetermined value that determines the distance to an obstacle is typically set as small as possible so that the robot can enter a smaller area, thus providing a more efficient travel route for luggage transport and the like.

### SUMMARY

However, if the predetermined value is set too small, the robot is more likely to come into contact with an obstacle. There is an issue of desirably setting an appropriate predetermined value in consideration of both perspectives.

The present disclosure has been made to solve such an issue, and the main object of the present disclosure is to provide a luggage transport system, a luggage transport method, and a storage medium that can expand the movable area of the robot and improve the transport efficiency by setting an appropriate predetermined value.

An aspect of the present disclosure for achieving the above object is a luggage transport system including: a transport robot that transports luggage to a destination while moving such that a distance from an obstacle does not become equal to or smaller than a predetermined value; and a predetermined value changing unit for changing the predetermined value according to at least one of the luggage, a moving speed of the transport robot, and a state of a road surface on which the transport robot moves. In this aspect, the luggage transport system may further include a luggage information acquisition unit for acquiring information on a kind of the luggage. The predetermined value changing unit may change the predetermined value according to the information on the kind of the luggage acquired by the luggage information acquisition unit. In this aspect, the luggage transport system may further include a weight detecting unit for detecting a weight of the luggage. The predetermined value changing unit may change the predetermined value according to the weight of the luggage detected by the weight detecting unit. In this aspect, the luggage transport system may further include a transport information acquisition unit for acquiring information on a transport method of the luggage to be transported by the transport robot. The predetermined value changing unit may change the predetermined value according to the information on the transport method of the luggage acquired by the transport information acquisition unit. In this aspect, the luggage transport system may further include a shape information acquisition unit for acquiring information on a shape of the luggage to be transported by the transport robot. The predetermined value changing unit may increase the predetermined value when the predetermined value changing unit determines that a contour of the luggage protrudes outside from a contour of the transport robot, based on the information on the shape of the luggage acquired by the shape information acquisition unit. In this aspect, the luggage transport system may further include a speed detecting unit for detecting the moving speed of the transport robot. The predetermined value changing unit may increase the predetermined value as the moving speed of the transport robot detected by the speed detecting unit increases. In this aspect, the luggage transport system may further include a friction detecting unit for detecting a friction coefficient of the road surface on which the transport robot moves. The predetermined value changing unit may increase the predetermined value as the friction coefficient of the road surface detected by the friction detecting unit decreases. In this aspect, the luggage transport system may further include a step detecting unit for detecting a step on the road surface around the transport robot. The predetermined value changing unit may increase the predetermined value when the step is detected by the step detecting unit. Another aspect of the present disclosure for achieving the above object may be a luggage transport method including: a step of transporting luggage to a destination by a transport robot while the transport robot moves such that a distance from an obstacle does not become equal to or smaller than a predetermined value; and a step of changing the predetermined value according to at least one of the luggage, a moving speed of the transport robot, and a state of a road surface on which the transport robot moves. Another aspect of the present disclosure for achieving the above object may be a storage medium storing a luggage transport program that causes a computer to execute: a process of transporting luggage to a destination by a transport robot while the transport robot moves such that a distance from an obstacle does not become equal to or smaller than a predetermined value; and a process of changing the predetermined value according to at least one of the luggage, a moving speed of the transport robot, and a state of a road surface on which the transport robot moves.

According to the present disclosure, a luggage transport system, a luggage transport method, and a storage medium that can expand the movable area of the robot and improve the transport efficiency by setting an appropriate predetermined value can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an outline view of a luggage transport system 1 according to a first embodiment;

FIG. 2 is a block diagram of the luggage transport system 1 according to the first embodiment;

FIG. 3 is a flowchart showing a flow of a luggage transport method according to the first embodiment; and

FIG. 4 is a diagram showing a configuration of a luggage transport system that is not provided with a host management device.

### DETAILED DESCRIPTION OF EMBODIMENTS

Hereinafter, the present disclosure will be described through embodiments of the disclosure, but the disclosure according to the claims is not limited to the following embodiments. Moreover, not all of the configurations described in the embodiments are indispensable for solving the problem. For the sake of clarity, the following description and drawings have been omitted and simplified as appropriate. In each drawing, the same elements are designated by the same reference signs, and duplicate descriptions are omitted as necessary.

### First Embodiment

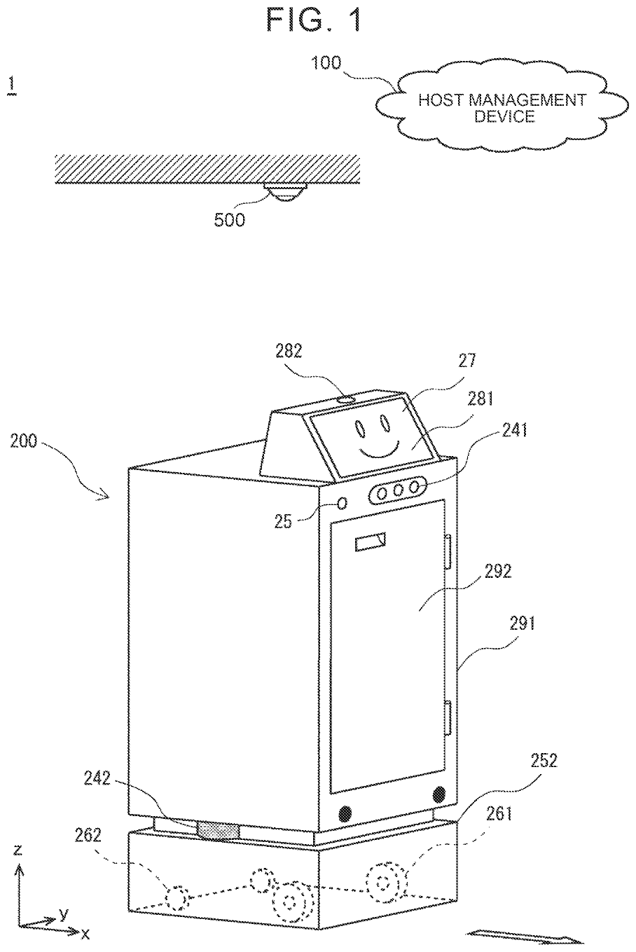

FIG. 1 is an outline view of a luggage transport system 1 according to a first embodiment. The luggage transport system 1 according to the first embodiment will be described with reference to FIG. 1. In the luggage transport system 1, a transport robot 200 that autonomously moves within a predetermined area transports luggage.

The luggage transport system 1 shown in FIG. 1 is an embodiment of the luggage transport system. For example, in a facility such as a hospital, the luggage transport system 1 can transport tableware carrying the patient's meal from the kitchen, tableware after the patient is finished with the meal to the kitchen, and luggage such as clothing, bed linen, medicine, and medical equipment to a preset location. The luggage transport system 1 has a host management device 100, a transport robot 200, and an environmental camera 500 as main configurations.

For convenience of describing the positional relationship of the components, FIG. 1 is provided with a Cartesian coordinate system indicating the x-axis, y-axis, and z-axis directions. The x-axis direction is the forward and backward directions of the transport robot 200, the y-axis direction is the right-left direction of the transport robot 200, and the z-axis direction is the height direction of the transport robot 200.

The host management device 100 grasps the situation in the facility by using the environmental camera 500 or the like, controls the transport robot 200, and transports the luggage. The host management device 100 may be installed in the facility where the transport robot 200 is operated, or may be installed in a place away from the facility. The host management device 100 has a communication function capable of communicating with equipment in the facility such as the transport robot 200 and the environmental camera 500.

The transport robot 200 is configured as an autonomous mobile robot that moves on the floor surface of a hospital or the like. The transport robot 200 can transport luggage contained in the transport robot 200 from a predetermined position (starting point) to another position (destination).

Here, the configuration of the transport robot 200 will be described in detail. The transport robot 200 shown in FIG. 1 is one of the modes of the autonomous mobile robot, and may be in another form.

As shown in FIG. 1, the transport robot 200 has a storage 291 for storing luggage and a door 292 for sealing the storage 291. The transport robot 200 moves autonomously to transport the luggage stored in the storage 291 to the destination instructed by the host management device 100.

On the exterior of the transport robot 200 according to the first embodiment, front-rear distance sensors 241 and right-left distance sensors 242 are provided as a distance sensor group. The front-rear distance sensors 241 and the right-left distance sensors 242 are composed of, for example, an ultrasonic sensor, a radar sensor, and the like. The transport robot 200 measures the distance between the transport robot 200 and an obstacle such as a person or an object in the front-rear direction by the front-rear distance sensors 241. The transport robot 200 measures the distance between the transport robot 200 and an obstacle in the right-left direction by the right-left distance sensors 242.

A wheel drive unit 252 is provided on the lower side of the storage 291. The wheel drive unit 252 is provided with drive wheels 261 and casters 262. The wheel drive unit 252 is composed of a motor, a speed reducer, and the like that drive the drive wheels 261. The drive wheels 261 are wheels for moving the transport robot 200 frontward, rearward, rightward, and leftward. The casters 262 are driven wheels that roll following the drive wheels 261 without being given a driving force.

A display unit 27, an operation interface 281, a camera 25, and the like are provided on the upper surface of the storage 291. The operation interface 281 is displayed on the display unit 27. An emergency stop button 282 is provided on the upper surface of the display unit 27. By pressing the emergency stop button 282, the autonomous movement of the transport robot 200 can be stopped.

The environmental camera 500 is fixed to a ceiling surface or the like in the facility where the transport robot 200 moves, and images the transport robot 200 moving below the environmental camera 500 and its surroundings from a fixed position.

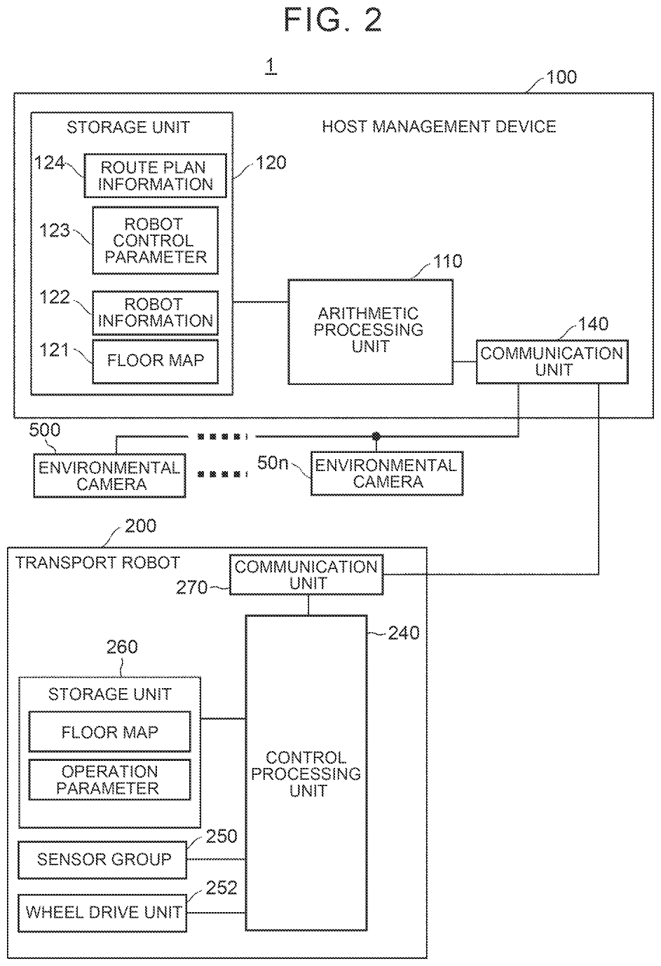

Next, the system configuration of the luggage transport system 1 will be described in detail with reference to FIG. 2. FIG. 2 is a block diagram of the luggage transport system 1 according to the first embodiment. The luggage transport system 1 includes the host management device 100, the transport robot 200, and environmental cameras 501 to 50n.

First, the host management device 100 will be described. The host management device 100 has an arithmetic processing unit 110, a storage unit 120, and a communication unit 140. The storage unit 120 stores a floor map 121, robot information 122, a robot control parameter 123, and route plan information 124.

The arithmetic processing unit 110 is, for example, an arithmetic device capable of executing a program such as a central processing unit (CPU), and can realize the processing described later by a luggage transport program.

The arithmetic processing unit 110 gives an operation instruction to the transport robot 200 according to a preset schedule. At this time, the arithmetic processing unit 110 gives an operation instruction to the transport robot 200 via the communication unit 140.

When giving the operation instruction, the arithmetic processing unit 110 grasps the starting point and the destination of the transport robot 200 with reference to the floor map 121, and refers to the route plan information 124 to transmit a movement procedure to the transport robot 200. Further, the arithmetic processing unit 110 determines the operating conditions of the arithmetic processing unit 110 with reference to the robot information 122 and the robot control parameter 123, and transmits the determined operating conditions to the transport robot 200 via the communication unit 140.

The arithmetic processing unit 110 is a specific example of a predetermined value changing unit. As the operating conditions, the arithmetic processing unit 110 changes and sets, for example, a predetermined value indicating a safety distance for the transport robot 200. The arithmetic processing unit 110 transmits the set predetermined value to the transport robot 200 via the communication unit 140.

The communication unit 140 is an interface that is communicably connected to the transport robot 200, and is composed of, for example, an antenna and a circuit that modulates or demodulates a signal transmitted via the antenna. The communication unit 140 is connected to the arithmetic processing unit 110, and supplies a predetermined signal received from the transport robot 200 by wireless communication to the arithmetic processing unit 110. The communication unit 140 transmits a predetermined signal received from the arithmetic processing unit 110 to the transport robot 200. The communication unit 140 is configured to enable wireless communication with the environmental cameras 501 to 50n.

Subsequently, the transport robot 200 will be described. The transport robot 200 has a control processing unit 240, a sensor group 250, the wheel drive unit 252, a storage unit 260, and a communication unit 270.

The control processing unit 240 is an information processing device having an arithmetic device such as a CPU, and acquires information from each configuration of the transport robot 200 and sends an instruction to each configuration. The control processing unit 240 controls the operation of the wheel drive unit 252.

The sensor group 250 is a general term for various sensors included in the transport robot 200. The sensor group 250 includes the above-mentioned distance sensor group, a posture sensor, a load sensor, a rotary encoder, a camera 25, and the like. The sensor group 250 is connected to the control processing unit 240 and supplies detected signals to the control processing unit 240.

The wheel drive unit 252 includes a motor driver for driving the motor of the drive wheels 261 and the like. The wheel drive unit 252 is connected to the control processing unit 240 and drives in response to an instruction from the control processing unit 240.

The storage unit 260 includes a non-volatile memory and stores a floor map and operation parameters. The floor map is a database necessary for the transport robot 200 to move autonomously, and includes the same information as at least a part of the floor map stored in the storage unit 120 of the host management device 100. The operation parameter includes a predetermined value as a safety distance transmitted from the arithmetic processing unit 110 of the host management device 100.

The control processing unit 240 controls the wheel drive unit 252 so that the distance between the transport robot 200 and the obstacle detected by the distance sensor group does not become equal to or smaller than a predetermined value that is an operation parameter set in the storage unit 120. This predetermined value is a safety distance to an obstacle detected by the distance sensor group. Thus, the transport robot 200 can move autonomously while keeping a safety distance from obstacles.

Typically, the above predetermined value that determines the distance to an obstacle is set to a value as small as possible so that the transport robot can enter a smaller area, thus providing a more efficient travel route for luggage transport. However, if the predetermined value is set too small, the transport robot is more likely to come into contact with an obstacle. There is an issue of desirably setting an appropriate predetermined value in consideration of both perspectives.

In view of this, the luggage transport system 1 according to the first embodiment changes the predetermined value according to the luggage transported by the transport robot 200. Thus, by setting an appropriate predetermined value according to the luggage, the movable area of the transport robot 200 can be expanded and the transport efficiency can be improved.

The arithmetic processing unit 110 of the host management device 100 may change a predetermined value according to the kind of luggage of the transport robot 200. Thus, an appropriate predetermined value can be set according to the kind of the luggage of the transport robot 200.

The arithmetic processing unit 110 is a specific example of a luggage information acquisition unit. The robot information 122 of the storage unit 120 may include information about the luggage to be transported by the transport robot 200. The arithmetic processing unit 110 may acquire information on the kind of the luggage stored in the storage 291 of the transport robot 200 from the robot information 122 of the storage unit 120.

The arithmetic processing unit 110 may acquire information on the kind of the luggage from the ID tag attached to the luggage. When the luggage is stored in the storage 291, the arithmetic processing unit 110 reads the ID tag of the luggage using a tag reader and recognizes the tag information associated with the ID tag to acquire information on the kind of the luggage. The arithmetic processing unit 110 may acquire information on the kind of the luggage from the image of the luggage captured by the environmental camera 500 or the camera 25 of the transport robot 200.

Based on the information on the kind of the luggage acquired as described above, when the arithmetic processing unit 110 determines that the luggage is fragile or is likely to be damaged such as tableware to be put away after a meal or chemicals, the arithmetic processing unit 110 increases the predetermined value. The arithmetic processing unit 110 may increase the predetermined value by adding or multiplying a margin value to the predetermined value set as a reference. The margin value may be set in advance for each kind of the luggage. An optimum margin value in consideration of safety may be experimentally obtained for each kind of the luggage, and the obtained margin value may be preset in the arithmetic processing unit 110.

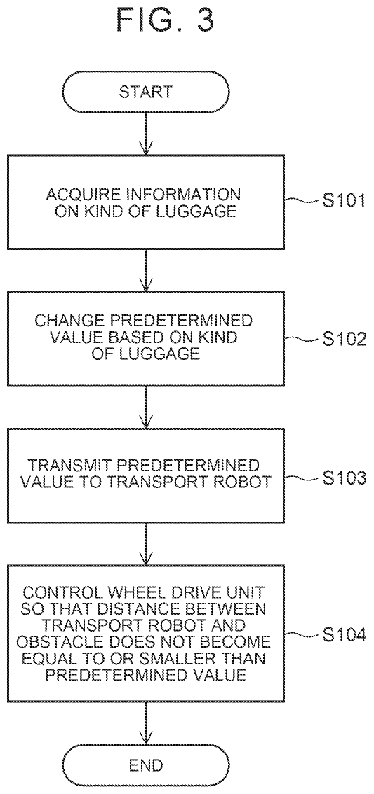

Subsequently, a luggage transport method according to the first embodiment will be described. FIG. 3 is a flowchart showing a flow of the luggage transport method according to the first embodiment.

The arithmetic processing unit 110 of the host management device 100 acquires information on the kind of the luggage stored in the storage 291 from the robot information of the storage unit 120 (step S101).

The arithmetic processing unit 110 changes and sets a predetermined value based on the acquired information on the kind of the luggage (step S102). The arithmetic processing unit 110 transmits the set predetermined value to the transport robot 200 via the communication unit 140 (step S103).

The control processing unit 240 of the transport robot 200 controls the wheel drive unit 252 so that the distance between the transport robot 200 and the obstacle detected by the distance sensor group does not become equal to or smaller than the predetermined value transmitted from the arithmetic processing unit 110 of the host management device 100 (step S104).

As described above, the luggage transport system 1 according to the first embodiment changes the predetermined value according to the kind of the luggage to be transported by the transport robot 200. Thus, by setting an appropriate predetermined value according to the kind of the luggage, the movable area of the transport robot 200 can be expanded and the transport efficiency can be improved.

### Second Embodiment

In a second embodiment, the arithmetic processing unit 110 of the host management device 100 changes a predetermined value according to the weight of the luggage to be transported by the transport robot 200. Thereby, an appropriate predetermined value can be set according to the weight of the luggage to be transported by the transport robot 200.

As the weight of the luggage transported by the transport robot 200 increases, the braking distance of the transport robot 200 increases accordingly. Thus, it is necessary to secure a large margin of distance from the obstacle. Therefore, the arithmetic processing unit 110 increases the predetermined value as the weight of the luggage stored in the storage 291 of the transport robot 200 increases.

The sensor group 250 may include a load sensor that detects the weight of the luggage stored in the storage 291 of the transport robot 200. The load sensor is provided in the storage 291 or the like. The load sensor is a specific example of a weight detecting unit. The arithmetic processing unit 110 may acquire information on the weight of the luggage from the ID tag attached to the luggage.

The arithmetic processing unit 110 increases the predetermined value as the weight of the luggage detected by the load sensor increases. The arithmetic processing unit 110 may calculate the predetermined value based on map information or table information indicating the relationship between the weight of the luggage and the predetermined value. The map information and the table information indicating a relationship in which the predetermined value increases as the weight of the luggage increases may be experimentally obtained in advance and set in the arithmetic processing unit 110.

The arithmetic processing unit 110 transmits the predetermined value set as described above to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Third Embodiment

In a third embodiment, the arithmetic processing unit 110 of the host management device 100 may change a predetermined value according to the transport method of the luggage to be transported by the transport robot 200. Thereby, an appropriate predetermined value can be set according to the transport method of the luggage to be transported by the transport robot 200.

In the first and second embodiments, the transport robot 200 stores the luggage in the storage 291 and transports the luggage, but the transport method is not limited to this. The transport robot 200 may transport the luggage by towing a trolley or the like on which the luggage is placed, loading the luggage on the upper part of the main body of the transport robot 200, or gripping the luggage with an arm or the like.

As described above, a plurality of methods for transporting luggage are assumed. However, the stability of the luggage when transporting the luggage differs according to each transport method.

For example, when the transport robot 200 stores the luggage in the storage 291 and transports the luggage, the luggage is inside the storage 291 and near the center of gravity of the transport robot 200, making the luggage stable. Further, even when the transport robot 200 grips the luggage with an arm or the like and transports the luggage, the luggage is fixed by the arm or the like and is therefore stable.

On the other hand, when the transport robot 200 tows the luggage mounted on the trolley and transports the luggage, the luggage is separated from the robot body, so that the luggage is more unstable than when the luggage is stored in the storage 291 and transported. Further, when the transport robot 200 loads the luggage on the upper part of the main body and transports the luggage, the luggage becomes more unstable than when the luggage is towed and transported as described above, considering the shaking of the transport robot 200 and the like. Therefore, an appropriate predetermined value is set according to each transport method in consideration of the stability of the luggage in each transport method.

The robot information 122 of the storage unit 120 may include information on a plurality of transport methods for the luggage to be transported by the transport robot 200. As described above, each transport method may be associated with a predetermined value optimal for each transport method in advance.

The arithmetic processing unit 110 is a specific example of a transport information acquisition unit. The arithmetic processing unit 110 may determine the method of transporting the luggage of the transport robot 200 based on the image captured by the environmental camera 500 or the camera 25 of the transport robot 200, or the robot information 122 of the storage unit 120.

The arithmetic processing unit 110 determines the method of transporting the luggage of the transport robot 200 as described above. Then, the arithmetic processing unit 110 transmits the predetermined value associated with the determined transport method of the luggage to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Fourth Embodiment

When the transport robot 200 transports the luggage by various transport methods as described above, the luggage may protrude to the outside of the transport robot 200 depending on the transport method. In this case, for example, when the transport robot 200 is viewed from above, the contour of the luggage protrudes outside from the contour of the transport robot 200. The protruding portion of the luggage approaches an obstacle before the transport robot 200 does, increasing the possibility of contact with the obstacle. Therefore, the above-mentioned predetermined value is set in consideration of the protruding portion of the luggage.

In view of this, in a fourth embodiment, the arithmetic processing unit 110 of the host management device 100 increases the predetermined value when it is determined that the contour of the luggage protrudes outside from the contour of the transport robot 200. Thereby, an appropriate predetermined value can be set according to the shape of the luggage to be transported by the transport robot 200.

The arithmetic processing unit 110 is a specific example of a shape information acquisition unit. For example, the robot information 122 of the storage unit 120 may include information on the shape of the luggage to be transported by the transport robot 200 (shape, size, etc. of the luggage), information on the shape of the transport robot 200 (shape, size, etc. of the transport robot 200), and the like. The arithmetic processing unit 110 acquires information on the shape of the luggage and information on the shape of the transport robot 200 from the robot information 122 of the storage unit 120.

The arithmetic processing unit 110 may acquire information on the shape of the luggage from the ID tag attached to the luggage. The arithmetic processing unit 110 may acquire information on the shape of the luggage from the image of the luggage captured by the environmental camera 500 or the camera 25 of the transport robot 200.

By comparing the shape of the luggage with the shape of the transport robot 200, the arithmetic processing unit 110 determines whether the contour of the luggage protrudes outside from the contour of the transport robot 200. The arithmetic processing unit 110 may determine whether the contour of the luggage protrudes outside from the contour of the transport robot 200 based on the image of the luggage captured by the environmental camera 500 or the camera 25 of the transport robot 200.

When the arithmetic processing unit 110 determines that the contour of the luggage protrudes outside from the contour of the transport robot 200, for example, the arithmetic processing unit 110 increases the predetermined value by adding or multiplying a margin value to a predetermined value set as a reference. An optimum value in consideration of safety may be experimentally obtained and set in the arithmetic processing unit 110 as a margin value.

The arithmetic processing unit 110 may change a predetermined margin value according to the protrusion amount of the luggage protruding from the transport robot 200. For example, the arithmetic processing unit 110 calculates the protrusion amount of the luggage based on the image of the luggage captured by the environmental camera 500.

The arithmetic processing unit 110 may calculate the margin value based on the map information or the table information indicating the relationship between the protrusion amount and the margin value. The map information and the table information indicating a relationship in which the margin value increases as the protrusion amount increases may be experimentally obtained in advance and set in the arithmetic processing unit 110.

The arithmetic processing unit 110 transmits the predetermined value calculated as described above to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Fifth Embodiment

As the moving speed of the transport robot 200 increases, the braking distance of the transport robot 200 increases, therefore, the predetermined value is increased as the safety distance. In view of this, in a fifth embodiment, the arithmetic processing unit 110 of the host management device 100 increases the predetermined value as the moving speed of the transport robot 200 increases. Thereby, an appropriate predetermined value can be set according to the moving speed of the luggage to be transported by the transport robot 200.

The arithmetic processing unit 110 is a specific example of a speed detecting unit. For example, the rotary encoder detects rotation information of the drive wheels 261 of the transport robot 200. The arithmetic processing unit 110 calculates the moving speed of the transport robot 200 based on the rotation information of the drive wheels 261 detected by the rotary encoder. The arithmetic processing unit 110 may calculate the moving speed of the transport robot 200 based on the image captured by the camera 25.

The arithmetic processing unit 110 calculates a predetermined value based on the moving speed of the transport robot 200 calculated as described above. The arithmetic processing unit 110 calculates a predetermined value based on, for example, the map information or the table information indicating the relationship between the moving speed of the transport robot 200 and the predetermined value. The map information and the table information in which the predetermined value increases as the moving speed of the transport robot 200 increases may be experimentally obtained in advance and set in the arithmetic processing unit 110.

The arithmetic processing unit 110 transmits the predetermined value calculated as described above to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Sixth Embodiment

In a sixth embodiment, the arithmetic processing unit 110 of the host management device 100 changes a predetermined value according to the road surface condition on which the transport robot 200 moves. Thereby, an appropriate predetermined value can be set according to the friction coefficient of the road surface on which the transport robot 200 moves.

The arithmetic processing unit 110 is a specific example of a friction detecting unit. The arithmetic processing unit 110 may increase the predetermined value as the friction coefficient of the road surface on which the transport robot 200 moves decreases.

As the friction coefficient of the road surface on which the transport robot 200 moves decreases, the braking distance of the transport robot 200 increases accordingly. Thus, it is necessary to secure a larger margin of distance from the obstacle. Therefore, the arithmetic processing unit 110 increases the predetermined value as the friction coefficient of the road surface on which the transport robot 200 moves decreases.

For example, the floor map 121 of the storage unit 120 includes information on the type of the road surface (concrete, tile, wood, carpet, rubber, etc.) on which the transport robot 200 moves. Information on the friction coefficient of the road surface may be associated with each type of the road surface in advance. The arithmetic processing unit 110 determines the type of the road surface on which the transport robot 200 moves based on the floor map 121 of the storage unit 120, and calculates the friction coefficient of the road surface. The arithmetic processing unit 110 may determine the type of the road surface on which the transport robot 200 moves based on the image captured by the environmental camera 500 or the camera 25.

The arithmetic processing unit 110 calculates a predetermined value based on the friction coefficient of the road surface on which the transport robot 200 moves that is calculated as described above. The arithmetic processing unit 110 calculates the predetermined value based on, for example, the map information or the table information indicating the relationship between the friction coefficient of the road surface and the predetermined value. The map information and the table information in which the predetermined value increases as the friction coefficient of the road surface on which the transport robot 200 moves decreases may be experimentally obtained in advance and set in the arithmetic processing unit 110.

The arithmetic processing unit 110 transmits the predetermined value calculated as described above to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Seventh Embodiment

When there is a step on the road surface around the transport robot 200 and the transport robot 200 rides over this step, the luggage is shaken by the impact. Therefore, the transport robot 200 increases the distance from the obstacle and avoids the obstacle with plenty of space therebetween.

In view of this, in a seventh embodiment, the arithmetic processing unit 110 of the host management device 100 increases a predetermined value when a step is detected on the road surface around the transport robot 200. Thereby, an appropriate predetermined value can be set according to the step on the road surface around the transport robot 200, and the luggage can be stably transported.

The arithmetic processing unit 110 is a specific example of a step detecting unit. The arithmetic processing unit 110 may detect a step on the road surface from an image of the road surface around the transport robot 200 that is captured by the environmental camera 500 or the camera 25 of the transport robot 200. The arithmetic processing unit 110 may detect a step on the road surface around the transport robot 200 based on the floor map 121 of the storage unit 120 of the host management device 100 or the floor map of the storage unit 260 of the transport robot 200, and the current position of the transport robot 200.

When the arithmetic processing unit 110 detects a step on the road surface around the transport robot 200, for example, the arithmetic processing unit 110 increases the predetermined value by adding or multiplying a margin value to a predetermined value set as a reference. An optimum value in consideration of safety may be experimentally obtained and set in the arithmetic processing unit 110 as a margin value.

The arithmetic processing unit 110 transmits the predetermined value calculated as described above to the control processing unit 240 of the transport robot 200 via the communication unit 140. The control processing unit 240 controls the wheel drive unit 252 so that the distance between the transport robot 200 and the obstacle detected by the distance sensor group does not become equal to or smaller than the predetermined value transmitted from the arithmetic processing unit 110.

### Eighth Embodiment

In the luggage transport system 1 described above, the functions provided in the host management device 100 and the transport robot 200 may be provided in either device depending on the usage. Functions such as the arithmetic processing unit 110 and the storage unit 120 of the host management device 100 may be provided in the transport robot 200.

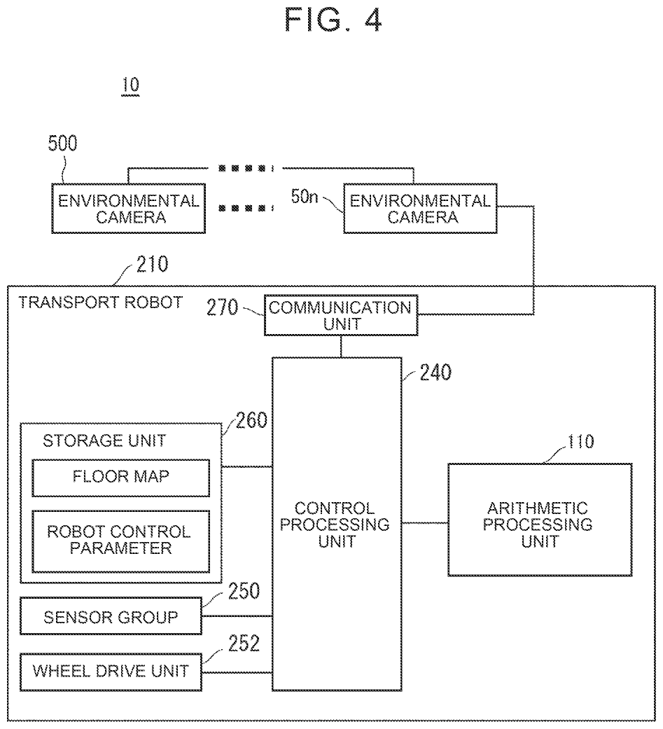

For example, as shown in FIG. 4, a luggage transport system 10 may have a configuration that does not include the host management device 100. The transport robot 210 further includes the arithmetic processing unit 110 in addition to the configuration of the first embodiment. Further, the luggage transport system 10 may be configured as a single transport robot 210 without including the environmental camera 500.

Although some embodiments of the present disclosure have been described, these embodiments are presented as examples and are not intended to limit the scope of the disclosure. These novel embodiments can be implemented in various other embodiments, and various omissions, replacements, and changes can be made without departing from the gist of the disclosure. These embodiments and modifications thereof are included in the scope and gist of the disclosure, and are also included in the disclosure described in the claims and the equivalent thereof.

The present disclosure can also be realized, for example, by causing a processor to execute a computer program regarding the processing shown in FIG. 3.

A program can be stored using various types of non-transitory computer-readable media and supplied to a computer. The non-transitory computer-readable media include various types of tangible storage media. Examples of the non-transitory computer-readable media include magnetic recording media (e.g. flexible disks, magnetic tapes, hard disk drives), magneto-optical recording media (e.g. magneto-optical disks), compact disc read-only memory (CD-ROM), compact disc recordable (CD-R), compact disc rewritable (CD-R/W), and semiconductor memory (e.g. mask ROM, programmable ROM (PROM), erasable PROM (EPROM), flash ROM, random access memory (RAM)).

A program may be supplied to the computer using various types of transitory computer-readable media. Examples of the transitory computer-readable media include electrical signals, optical signals, and electromagnetic waves. The transitory computer-readable media can supply a program to a computer via a wired communication path such as an electric wire and an optical fiber, or a wireless communication path.

Each unit constituting the luggage transport systems 1 and 10 according to the above-described embodiments is not only realized by a program, but a part or all of the units may be realized by dedicated hardware such as application-specific integrated circuit (ASIC) and field-programmable gate array (FPGA).

What is claimed is:

1. A luggage transport system comprising:
a transport robot that transports luggage to a destination while moving such that a distance from an obstacle does not become equal to or smaller than a predetermined value; and
a predetermined value changing unit for changing the predetermined value according to at least one of the luggage, a moving speed of the transport robot, and a state of a road surface on which the transport robot moves.

2. The luggage transport system according to claim 1, further comprising a luggage information acquisition unit for acquiring information on a kind of the luggage, wherein the predetermined value changing unit changes the predetermined value according to the information on the kind of the luggage acquired by the luggage information acquisition unit.

3. The luggage transport system according to claim 1, further comprising a weight detecting unit for detecting a weight of the luggage, wherein the predetermined value changing unit changes the predetermined value according to the weight of the luggage detected by the weight detecting unit.

4. The luggage transport system according to claim 1, further comprising a transport information acquisition unit for acquiring information on a transport method of the luggage to be transported by the transport robot, wherein the predetermined value changing unit changes the predetermined value according to the information on the transport method of the luggage acquired by the transport information acquisition unit.

5. The luggage transport system according to claim 1, further comprising a shape information acquisition unit for acquiring information on a shape of the luggage to be transported by the transport robot, wherein the predetermined value changing unit increases the predetermined value when the predetermined value changing unit determines that a contour of the luggage protrudes outside from a contour of the transport robot, based on the information on the shape of the luggage acquired by the shape information acquisition unit.

6. The luggage transport system according to claim 1, further comprising a speed detecting unit for detecting the moving speed of the transport robot, wherein the predetermined value changing unit increases the predetermined value as the moving speed of the transport robot detected by the speed detecting unit increases.

7. The luggage transport system according to claim 1, further comprising a friction detecting unit for detecting a friction coefficient of the road surface on which the transport robot moves, wherein the predetermined value changing unit increases the predetermined value as the friction coefficient of the road surface detected by the friction detecting unit decreases.

8. The luggage transport system according to claim 1, further comprising a step detecting unit for detecting a step on the road surface around the transport robot, wherein the predetermined value changing unit increases the predetermined value when the step is detected by the step detecting unit.

9. A luggage transport method comprising:
a step of transporting luggage to a destination by a transport robot while the transport robot moves such that a distance from an obstacle does not become equal to or smaller than a predetermined value; and
a step of changing the predetermined value according to at least one of the luggage, a moving speed of the transport robot, and a state of a road surface on which the transport robot moves.

10. A non-transitory storage medium storing a luggage transport program that causes a computer to execute:
a process of transporting luggage to a destination by a transport robot while the transport robot moves such that a distance from an obstacle does not become equal to or smaller than a predetermined value; and
a process of changing the predetermined value according to at least one of the luggage, a moving speed of the transport robot, and a state of a road surface on which the transport robot moves.
